(19) United States
(12) Patent Application Publication
(10) Pub. No.: US 2015/0242407 A1
(43) Pub. Date: Aug. 27, 2015

(54) Discovery of Data Relationships Between Disparate Data Sets

(71) Applicant: SourceThought, Inc., San Juan Capistrano, CA (US)

(72) Inventors: Ron Frohock, Trabuco Canyon, CA (US); Chhay Taing, Irvine, CA (US); Chris Andrade, Rancho Santa Margarita, CA (US); Karl Gierach, Irvine, CA (US); Michael Ransom Pennell, San Clemente, CA (US)

(21) Appl. No.: 14/628,810

(22) Filed: Feb. 23, 2015

Related U.S. Application Data
(60) Provisional application No. 61/943,320, filed on Feb. 22, 2014.

(51) Int. Cl. G06F 17/30

(52) U.S. Cl. CPC G06F 17/3053; G06F 17/30289

(57) ABSTRACT

A system for synthesizing new datasets from a corpus of data sources is disclosed. The system analyzes attributes between the different datasets between the data sources to determine if there are possible relationships between the attributes. Where a possible relationship is identified, the system could generate a confidence metric between 0%-100% reflecting how likely it is that the attributes are related. The system could then synthesize a new dataset as a function of the generated confidence metric.

This application claims the benefit of priority to U.S. provisional application 61/943,320 filed on Feb. 22, 2014. This and all other extrinsic references referenced herein are incorporated by reference in their entirety.

### FIELD OF THE INVENTION

The field of the invention is data integration systems.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Many computer systems collect, aggregate, and process data in order to perform tasks and run analytics. There has been, and will likely continue to be, a significant increase in the volume and variety of data available to organizations from various disparate sources. The term “Big Data” is often used to describe this trend. Organizations oftentimes seek ways to use such data in order to gain insight, improve performance, and develop predictive models. Efficiently using data from disparate sources oftentimes requires combining the data into a single dataset before processing the data, which is difficult when each data source has different structures formats, keys, and attributes.

U.S. Pat. No. 5,894,311 to Jackson teaches a system that automatically joins tables when a user selects database variables from different database tables. When a user selects the two variables, the system generates an on-the-fly join command of the tables by using a unique key, such as a customer account variable, that is common to both tables. Jackson's system, however, requires the system to already know what variables are unique to a user, and what variables are common to both tables, to use such variables as a key to join multiple tables. There are many situations when a user might want to join data from a plurality of data sources, but doesn't know what key to use in order to join the different sets of data into a single data source.

US 2011/0320433 to Mohiuddin teaches a system that allows a database administrator to create a database baseview for each table, and associates primary key metadata for the baseview. Mohiuddin's system could then join the tables based upon the primary key metadata in each table's baseview. However, it is oftentimes unrealistic to require a database administrator to create a database baseview for each and every table in a database, since such tasks are quite time-consuming.

US 2012/0330988 to Christie teaches a system that automatically generates queries to join one table with another table. The database creates a table index for one of the tables to identify unique values contained in a column of the table. Then, the system could automatically generate a query to join the indexed table with a non-indexed table based upon the unique values that the database found. Exact matches between columns from two tables, however, might not always be appropriate or practicable, for example when the tables are very large, from different time periods, or have inconsistent structures. Also, exact column matches may not always indicate that columns can be used to join the tables. If the fields are dates, overlapping consecutive integers or have low uniqueness, other information is needed to make a determination whether the columns can be used to join the tables.

Thus, there remains a need for a system and method to join datasets from disparate sources.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. A “functional coupling” between two or more electronic devices is intended to include both wired and wireless connections between the electronic devices such that a signal can be sent from one electronic device to another electronic device.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems, and methods in which a computer system synthesizes data structures from a corpus of data sources.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on it tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service. APIs, known financial transaction protocols, or other electronic information exchanging methods. Data exchanges preferably are conducted over a packet-switched network, the Internet, LAN, WAN, VPN, or other type of packet switched network. Data received by the computer system is typically stored and processed in a non-transitory computer readable storage medium.

The computer system generally has a data collection module configured to receive one or more datasets from various data sources through a wired or wireless interface (e.g. a serial port, an Internet connection). As used herein, a “data source” is a computer device that transmits a dataset to one or more computer systems. Preferably, such data sources save the dataset on a non-transitory computer-readable medium, such as a file repository, a relational database management system, and a cloud service. Such data sources could be structured (e.g. DBMS or poly-structured (e.g. XML. JSON, log files, sensor outputs). A single data source could house one or more datasets and a single computer system could access one of more data sources. While some data sources may have metadata on datasets, such as an indicator that an attribute of a database table is a key attribute, other data sources could simply be comma-separated values (csv) that may or may not contain column headings. As used herein, an “attribute” of a dataset is a characterization of a discrete subset of values within the dataset. In a standard database table, a column could be considered an attribute and each column/row intersection, could be considered a value.

The computer system also has a synthesizing engine configured to establish a relationship between one or more attributes of a first dataset and one or more attributes of a second dataset—typically to determine whether it would be appropriate to join both datasets using those attributes as a join key. The synthesizing engine can be configured to conform the data attributes that have a relationship to one another. Conforming attributes is to perform one or more transformations on one or both attributes to make like values identical so they can be used to join the datasets. Each relationship is then rated using a Relationship Confidence Metric (RCM), typically measured between 0% and 100%, between an attribute of one dataset and an attribute of another dataset as a function of the possible relationship. The RCM is used by the system to indicate a likelihood of a relationship between the two attributes. Since a system is rarely 100% confident that two attributes have a relationship with one another (especially attributes from disparate data sources), most of the RCMs will be less than 100%.

A synthesizing engine typically establishes relationships using one or more advisors that indicate the likelihood of a relationship between two attributes. Contemplated advisors include profile advisors, structural analysis advisors, data similarity advisors, and entity resolution advisors. One or more of these contemplated advisors may not be used if it is determined that they do not significantly improve the calculation of RCM. Similarly, new advisors may be added if it is determined they can improve the calculation of RCM.

Profile advisors typically construct profile results for each attribute and compare the profile results to one another to determine whether the profiles are related to one another. A profile of a data attribute could be generated as a function of values of the data attribute. For example, a profile of a data attribute spanning a plurality of numerical values could be the largest numerical value of all of the values characterized by the data attribute. Profile results are generally then calculated by comparing the profile of one attribute against the profile of another attribute. Each profile result is generally weighted differently by the synthesizing engine to generate the RCM and combination of profile results typically combined using decision trees can be used and weighted to generate the RCM.

Structural analysis advisors typically construct structural analysis results based on structural information about the attributes. Such structural information is typically contained within metadata for an attribute or dataset. Such metadata could include, for example, the name of a data attribute, a data type of a data attribute, or an indicator of whether the attribute is a key attribute (e.g. primary key, foreign key). Each structural analysis result is generally weighted differently by the synthesizing engine to generate the RCM.

Similarity advisors typically construct a similarity result based on a data similarity between actual values of a data attribute for a first dataset and actual values of a data attribute. For a second dataset. For example, attributes that have a high number of unique values that are the same would be more similar than attributes that have a low number of unique values that are the same. Each similarity result is generally weighted differently by the synthesizing engine to generate the RCM.

Entity resolution advisors typically apply algorithms to determine whether a data attribute is an entity ID or not. As used herein, an “entity ID” is a primary key to a dataset or entity. For example, a social security number in a dataset including employee information could be categorized as an entity ID for a person. Each finding of whether a data attribute is an entity ID is generally weighted differently by the synthesizing engine to generate the RCM.

The synthesizing engine typically aggregates result data from each of the aforementioned advisors, and weights them according to an algorithm to generate an RCM between 0% and 100%. When the RCM for relationships derived between attributes of a plurality of datasets have been generated by the synthesizing engine, a data consolidation engine could synthesize a new dataset from two or more datasets as a function of the RCMs. In some embodiments, the data consolidation engine automatically synthesizes the new dataset by automatically selecting the relationship associated with the highest RCM to join datasets with one another. In other embodiments, the data consolidation engine only selects a relationship when the generated RCM is at least a defined threshold, for example at least 40%, 50%, 60%, 70%, or 80%. Such thresholds are generally defined through a user interface by an administrator.

The system also typically has one or more logs that keep track of a usage history of historical queries that have used in the system, either by the computer system or by the data sources. The historical queries typically show how often certain attributes have been used to join datasets into a new dataset. The synthesizing engine could have a query analyzer that generates a frequency count as a function of the usage history, where the frequency count counts the number of times a query has been entered that contains two attributes. The synthesizing engine could then be configured to modify the RCM as a function of the frequency count.

In other embodiments, a user interface module could present the confidence metrics to a user interface, allowing a user to review the various derived relationships and confidence metrics and select a relationship to base the data structure synthesis upon. The selection could then be received by the system through the user interface, such that the received selection triggers the data consolidation engine to synthesize the data structure.

In some embodiments, the attributes of a selected relationship might be related to one another, but may need to be conformed before the datasets are joined together using the attributes. For example, leading, trailing and imbedded characters such as a “-” can be removed or an integer can be converted to a string field. When such a situation occurs, the data consolidation engine preferably generates a key transform that maps values of one attribute to values of another to ease in the synthesis of the new dataset.

Various objects, features, aspects and advantages of the inventive subject matter will become more apparent from the following detailed description of preferred embodiments, along with the accompanying drawing figures in which like minerals represent like components.

One should appreciate that the disclosed techniques provide many advantageous technical effects including the ability to join previously unknown disparate datasets into a new dataset.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is a hardware layout of an exemplary inventive system.

FIG. 2 is a software layout of the computer system in FIG. 1.

FIG. 3 shows an exemplary universe graph of a plurality of datasets.

### DETAILED DESCRIPTION

The inventive subject matter provides apparatus, systems, and methods in which a computer system synthesizes data structures from a corpus of data sources. The inventive subject matter provides a unique and novel approach to determine a relative relationship among unknown sets of data attributes. These attributes could then be leveraged in a number of different ways to provide context for both computer and human interaction. The inventive system performs a number of analytic steps on a number of aspects of data attributes to construct a belief in a relationship between attributes of datasets, known as a Relationship Confidence Metric (RCM).

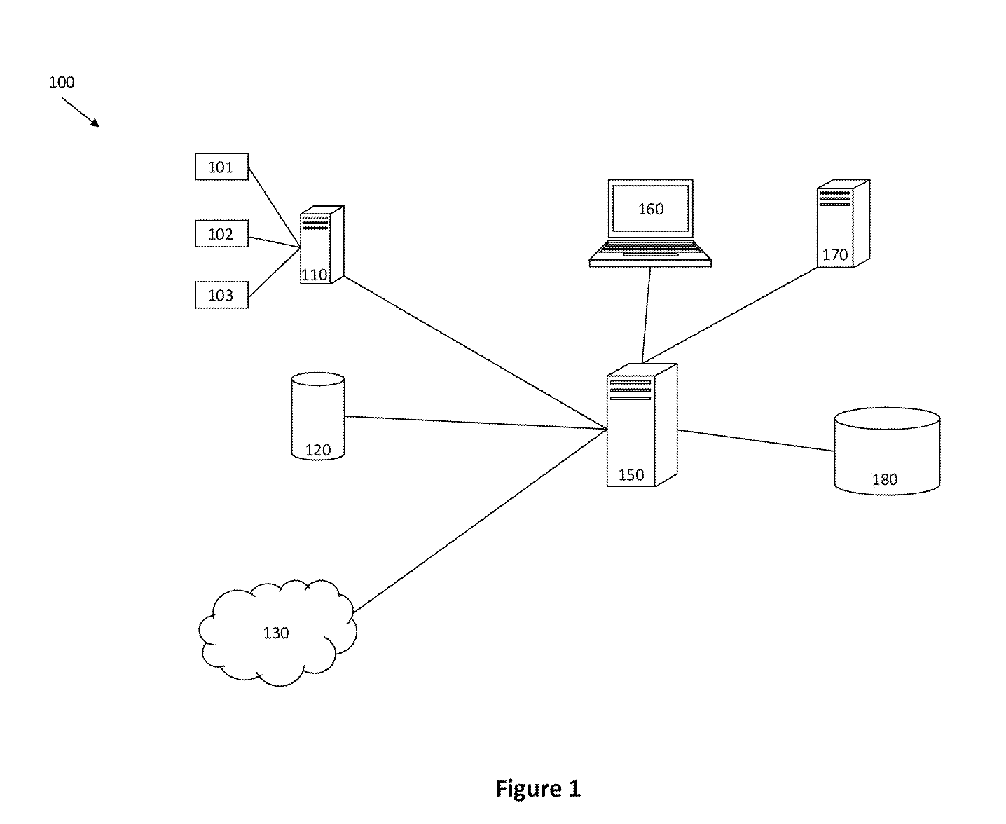

In FIG. 1, a system has data sources 110, 120, and 130 are functionally connected to computer system 150, which is functionally connected to user interface 160, calling computer system 170, and data repository 180. Data source 110 is as a computer system 110 that collects data from sensors 101, 102, and 103 and stores data collected from each sensor into datasets saved in a memory. Such data sources typically store collected information in a text log file, such as a log, csv, JSON or an XML file. Data source 120 is a DBMS, such as SQL® or Oracle®, that keeps data in a structured environment, and typically keeps metadata log files on its datasets. Data source 130 is a cloud storage repository holding many different types of structured and poly-structured datasets. While data sources 110, 120, and 130 are shown as a poly-structured data source, a structured data source, and a multi-structured data source, any number of data sources and any type of data source could be used without departing from the scope of the invention. The data sources coupled to computer 150 could number in the hundreds or even thousands, to provide a large corpus of datasets that may or may not be known to computer system 150, where many of the data sources might use different types of data structures.

Computer system 150 is functionally coupled to data sources 110, 120, and 130 in a manner such that computer system 150 could receive or retrieve datasets from data sources 110, 120, and 130. While computer system 150 could be physically coupled to each data source 110, 120, and 130, computer system 150 is preferably functionally coupled to each data source through a network link, such as an intranet or the Internet. Computer system 150 is configured to retrieve datasets from the various data source 110, 120, and 130, and consolidate the data sets into one or more new datasets, which are saved in data repository 180—a non-transitory computer readable medium functionally coupled to computer system 150. Data repository 180 could also be considered a data source having one or more datasets that computer system 150 could draw upon. Data repository 180 also typically contains a historical log of the retrieving, profiling, querying and conforming of the data and the associated user interactions to enable the system to “learn” from itself.

Computer system 150 could be controlled by user interface 160, which is shown as a display screen and a keyboard, but could comprise any known user interface without departing from the scope of the invention, such as touch screens or terminal devices. In a typical embodiment, a user might access computer system 150 through user interface 160 to request that two or more datasets be analyzed to derive associated relationships and RCMs. A user interface might also define criteria for a regular dataset poll such as data source location and data source type such that computer system 150 will analyze the data source automatically based on a periodic schedule or an event such as a file transfer of an updated dataset from that data source. Through user interface 160, a user could select two or more attributes from two or more datasets. After selecting a first dataset and/or or a first attribute from the first data source, the user interface could present (or select from a list provided to user interface 160) other attributes from datasets that are related to the first dataset or attribute. Computer system 150 could compile a list of related datasets as those that have an attribute with a relationship link (a direct relationship link with one another or an indirect relationship link through one or more other datasets) with the first selected dataset or attribute where each relationship has an RCM exceeding a defined threshold specified by the user (e.g. 75%). Computer system 150 could then present the information to user interface 160, preferably by showing the recommended highest RCM relationship path between the first selected dataset or attribute to other attributes through any intermediate datasets. The user can select additional attributes from related datasets in a similar manner and can select a different relationship path from a list of all potential relationships or select relationships with an RCM above the specific threshold. The dataset may have already been retrieved, or if not, any selected datasets and associated attributes would then be retrieved from data sources 110, 120, and 130.

In other embodiments, computer system 150 might automatically pick the relationships as a function of the RCMs, for example by selecting the relationships with the highest RCMs to join the datasets. Computer system 150 would then construct the new dataset, store the new dataset in memory, such as a local memory or in data repository 180, and display the data structure to user interface 160.

In other embodiments, calling computer system 170 could request data from computer system 150 through an application program interface (API) which is preferably implemented as REST HTTP requests but can be implement using different API frameworks. Using the API, calling computer system 170 could request two or more attributes from 2 or more datasets to be retrieved from data sources 110, 120, and 130, preferably from a list of available attributes. Computer system 150 would then either 1) provide the selected attributes based on joining the data sets using automatically selected relationships (e.g. selected by choosing the join paths with the highest RCM values) or 2) provide a response through the API with the various relationships and allowing calling computer system 170 to respond with a selection of specific relationships to be used to join the datasets. Computer system 150 would then construct the new dataset, store the new dataset in memory, such as a local memory or in data repository 180 so that computer system 170 could retrieve it or pass the dataset directly to computer system 170 through the API.

By constructing RCMs for a large corpus of data attributes, the system eliminates, or at least substantially reduces, the requirement for human users to investigate each and every dataset and construct a data attribute map. This enables faster integration of new data attributes to the corpus, which streamlines the ability for a system to derive new and constructive meaning.

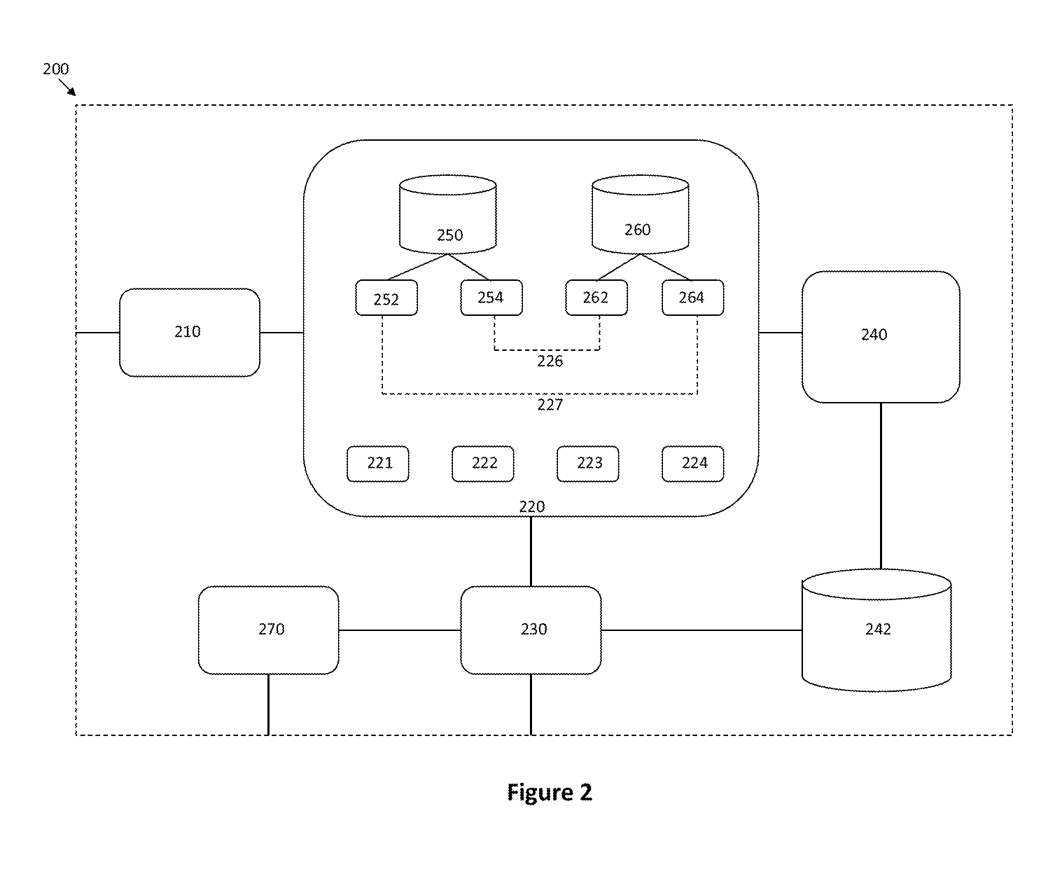

In FIG. 2, an exemplary software schematic 200 of computer system 150 is shown, having a data collection module 210, synthesizing engine 220, interface module 230, API module 270, and data consolidation engine 240. Data collection module 210 is a software module that is configured to collect any number of datasets from any number of data sources coupled to computer system 150. Data collection module 210 could be configured to process requests that are submitted by a user entity through interface module 230, for example from a user interface (not shown) or from a calling computer system (not shown) through API module 270. In some embodiments, the user might not submit a direct request for specific datasets, but might instead submit a request for specific attributes. Where a user requests attributes, data collection module 210 could be configured to verify relevant datasets have already been retrieved or retrieve the relevant datasets that contain the requested attributes. In other embodiments, data collection module 210 is configured to retrieve all datasets, or metadata from all datasets, in order to perform a relationship analysis. Here, data collection module 210 has retrieved dataset 250 having attributes 252 and 254 and dataset 260 having attributes 262 and 264, and has passed them to synthesizing 220 for analysis.

Synthesizing engine 220 has a plurality of advisor committees—profile committee 221, structural analysis committee 222, data similarity committee 223, and entity resolution committee 224—which are used by synthesizing engine 220 to recognize relationships and provide relationship results that are used to construct an RCM for a relationship. Each committee could have any number of advisors. While synthesizing engine 220 is shown with four advisor committees, more or less advisor committees could be used without departing from the scope of the invention. In order to construct an RCM, synthesizing engine 220 subjects data attributes 252, 254, 262, and 264 to the automated advisors for analysis. Each advisor provides a different expertise in specific areas of interrogating data attributes in order to determine whether a relationship exists, and how likely the relationship is to exist. Each advisor committee 221, 222, 223—and 224 weights each of its advisor results according to an algorithm, and the weighted results are all then assembled into a single aggregated result—the RCM. Here, the advisor committees have determined that there is a possible relationship between attribute 254 and 262 having an RCM of 226, and a possible relationship between attribute 252 and 264 having an RCM of 227.

Machine learning and statistical analysis could be utilized to tune contributions of individual advisors and/or committees to the RCM. For example, users and calling systems could select certain relationships, or join paths, over other relationships, influencing synthesizing engine 220 to alter its weight measurements to match the selected relationships. By analyzing historical relationship paths, users could train synthesizing engine 220 to weigh certain advisor results over other advisor results by validating particular relationships. Based on usage and user validation of relationships, the RCM algorithms could adjust to increase the RCM of newly discovered relationships with characteristics similar to relationships that have been used and validated to join data sets. Conversely, the RCM algorithms could adjust to decrease the RCM of newly discovered relationships with characteristics similar to relationships that have not been used to join data sets.

Profile committee 221 generally comprises one or more profiling advisors that comprise a series of heuristic examinations targeting the composition of data attributes. Exemplary heuristic examinations include various statistical calculations, such as similar minimum, maximum, mean, standard deviations, cardinality of data attribute values, uniqueness of data attribute values, length of attributes, and an attribute range overlap ratio. Frequency distribution of common formats including text, numeric and character patterns along with the frequency of particular data attribute values such as blanks, nulls and 0's are also key measures could also be utilized across profiling advisors. Each heuristic examination generates a profile for a first attribute of a first dataset and a separate profile for a second attribute for a second dataset, and then compares the profile results against one another to calculate the profile advisor result, typically between 0% and 100%.

For example, where a profiling advisor examines how similar each attributes mean is relative to one another, the heuristic examination would generate a profile of the mean of the first attribute in the first dataset, a profile of the mean of the second attribute in the second dataset. The profile advisor would compare each of the means against one another (typically by placing the smaller mean in the numerator and the larger mean in the denominator) to produce a profile advisor result. If the means are exactly the same, the profile advisor result would be 100%. But if the mean of one attribute in one dataset was 80 and the mean of the other attribute in the other dataset was 100, then the profile advisor result would be 80%.

Structural analysis committee 222 generally comprises one or more structural analysis advisors that utilize cues provided in description of data attributes or metadata consumed regarding data attributes from a source system (such as a DBMS) or imbedded in the source file (e.g. column headers, xml tags). Exemplary structural analysis advisors algorithms include an evaluation of the similarity of data attribute names, reference data attributes, whether both data attribute names are synonyms, an indicator of whether an attribute is a primary key, an indicator of whether an attribute is a foreign key, and an indicator of whether the attributes are related as primary and foreign keys. Structural analysis advisors contemplate utilization of linguistic approaches such as abbreviation normalization or synonym expansion to determine possible attribute name similarity. Each structural analysis advisor generates a structural analysis result, typically between 0% and 100%, as a function of structural information about the pair of attributes.

For example, where a structural analysis advisor attempts to determine whether two attributes are synonyms of one another, the structural analysis advisor might look up the name of the first attribute to find a list of synonyms for the first attribute, look up the name of the second attribute to find a list of synonyms for the second attribute, and would return 100% if either attribute were found in the other list of synonyms, 50% if the synonyms of one attribute were found in the list of synonyms of the other attribute, and a 0% of if there was no overlap in the list of synonyms.

Data similarity committee 223 generally comprises one or more data similarity advisors that comprise one or more algorithmic evaluations across the values of data attributes to locate data attributes that have content from the same set of values. Since calculating exact matches for a large population of data attributes is computationally expensive, data similarity advisors preferably work to determine relevant sample data sets for evaluations, for example by only searching attributes that have already returned a non-zero relationship from another advisor. Advisors can preferably request additional data attribute value samples to aid in confirming prior findings. Similarity measures utilized include, but are not limited to, Jacquard Similarity Coefficients, Overlap Coefficients, Dice Coefficients and Morista-Indexes.

Data similarity advisors preferably include the capability of constructing a transformation, which conforms one or both data attribute allowing them to match the other attribute in the other dataset. These transformations could be formed by an ordered set of simple character manipulation or mathematical conversions of one or more data attributes. For example, a data similarity advisor might apply a transformation to an attribute to convert a social security number with embedded dashes to remove the dashes.

Entity resolution committee 224 generally comprises one or more entity resolution advisors that assess whether one, or both, of the attributes are entity IDs. For example, an entity resolution advisor might determine that an attribute has values that are all unique, indicating that the attribute has a high likelihood of being an entity ID. In another embodiment, an entity resolution advisor might search for all historical entity IDs that have been used by other users, and could indicate that an attribute was used as an entity ID in a previous join. Relationships where both attributes are recognized as entity IDs are ranked higher than relationships where only one attribute is ranked as an entity ID.

Each of the results from the advisors are generally weighted by synthesizing engine 220 according to an algorithm that aggregates all of the advisors results into a single RCM. Advisors from the same or different committees can be combined typically using decision trees to create new advisors which can then be weighted and included in the RCM calculation or can set the RCM to 0 thereby eliminating the relationship. For example, a Boolean field (structural advisor) that has only 1 value (profile advisor) cannot be a joinable key. Each of the weights for each of the results preferably adds up to be 100%, although in some embodiments the weights might add up to be more or less than 100%.

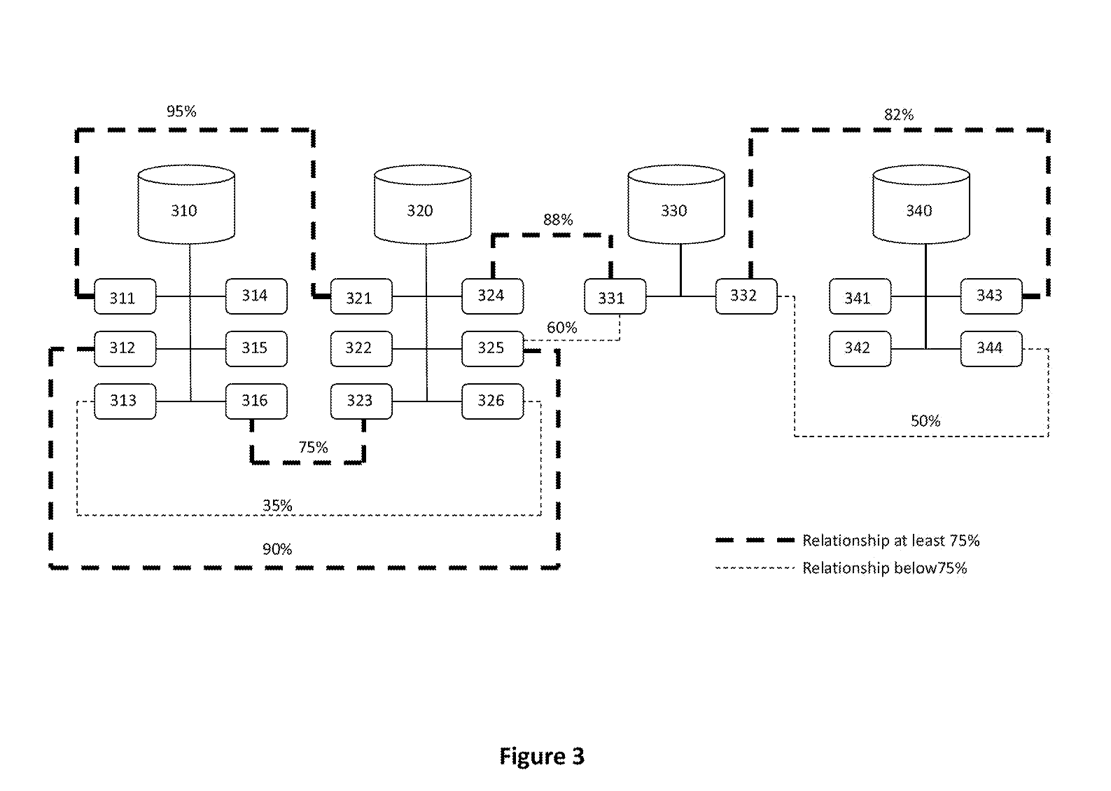

In FIG. 3, an exemplary graph 300 shows the RCM relationships between datasets 310, 320, 330, and 340. Each dataset 310, 320, 330, and 340 has been retrieved by a data collection module from one or more data sources. Dataset 310 comprises attributes 311, 312, 313, 314, 315 and 316. Dataset 320 comprises attributes 321, 322, 323, 324, 325, and 326. Dataset 330 comprises attributes 331 and 332. Dataset 340 comprises attributes 341, 342, 343, and 344. Each attribute is represented as nodes in the graph, with a line representing a relationship to a dataset, and a dotted line representing a relationship that has been recognized by the synthesizing engine.

A synthesizing engine has analyzed each dataset and attribute, and has determined that there exists a relationship between attributes 311 and 321 having an RCM of 95%, a relationship between attributes 312 and 325 having an RCM of 90%, a relationship between attributes 313 and 326 having an RCM of 35%, a relationship between attributes 325 and 331 having an RCM of 60%, a relationship between attributes 316 and 323 having an RCM of 75%, a relationship between attributes 324 and 331 having an RCM of 88%, a relationship between attributes 332 and 343 having an RCM of 82%, and a relationship between attributes 342 and 344 having an RCM of 50%. The RCM has been calculated by aggregating weighted results between automated advisors analyzing each relationship based upon various algorithms. No relationships have been found for attributes 315, 322, 341, or 342.

A threshold amount of 75% has been used to illustrate which relationships are preferred. In an exemplary embodiment, the system would be configured to only use, or display, relationships having an RCM value at of above the threshold amount. The threshold amount could be set by a user or by a computer algorithm. In an embodiment where a user chooses which relationship to use, the computer system might indicate to the user that only one relationship can be used to join dataset 320 to dataset 330 (the relationship between attributes 324 and 331), only one relationship can be used to join dataset 330 to dataset 340 (the relationship between attributes 332 and 343), but three different relationships could be used to join relationship dataset 310 to dataset 320 (the relationship between attributes 311 and 321, between attributes 312 and 325, and between 316 and 323). A user interface could be presented to the user that illustrates the three relationships ranked by RCM value (e.g. 311-321:95%, 312-325:90%, 316-323:75%). In another embodiment, the computer system could automatically choose to combine the four datasets using the highest ranked relationships. A user could then be presented with a new dataset having all of the combined attributes, or could have unwanted attributes filtered out depending upon user preferences.

Graph 300 provides an easy way for a system or a user to assess the most likely and valuable join between datasets. For each of the dataset pairs in FIG. 3, the highest RCM between datasets is the most likely join key (e.g. join path 311 and 321). However, other relationships are still valuable if they are at or above the threshold amount, and are useful to show a user should the user wish to use an alternative high RCM join path. User interfaces or calling systems could be configured to select different relationship edges to use under different circumstances, and the RCM will indicate the likelihood that the join will produce usable results.

Another use of the system is to provide indirect joins using an RCM. For example, where a user or a system wishes to join dataset 320 with dataset 340, which the system analyzed and didn't find any attributes that had a common relationship, the system determined that utilizing dataset 330 could provide a join option. If the system joins dataset 320 with dataset 330 using the relationship between attributes 324 and 331, and then joins dataset 330 with dataset 340 using the relationship between attributes 332 and 343, the system could create a new dataset containing attributes from both dataset 320 and dataset 340. The system could also inform a user that a less reliable join path, the join path between attributes 332 and 344, could be used if the threshold were set to a lower 50% level.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for synthesizing a new dataset, comprising:
a computer readable memory;
a data collection module that stores a first dataset from a first data source on the memory and a second dataset from a second data source on the memory;
a synthesizing engine configured to (a) establish a first possible relationship between a first data attribute of the first dataset and a second data attribute of the second dataset and (b) generate a first confidence metric of less than 100% between the first data attribute and the second data attribute as a function of the first possible relationship indicating a likelihood that the first and second data attributes are related; and
a data consolidation engine that synthesizes the new dataset from the first data source and the second data source as a function of the first confidence metric between the first data attribute and the second data attribute and stores the synthesized new dataset on the memory.

2. The system of claim 1, wherein the synthesizing engine establishes the first possible relationship using a profile advisor configured to derive a first profile as it function of values of the first data attribute and a second profile of values of the second data attribute.

3. The system of claim 2, wherein the profile advisor is further configured to generate a profile result as a comparison between the first profile and the second profile.

4. The system of claim 1, wherein the synthesizing engine establishes the first possible relationship using a structural analysis advisor configured to generate a structural analysis of at least one of (a) metadata for the first data attribute and (b) metadata for the second data attribute.

5. The system of claim 4, wherein the metadata for the first data attribute comprises at least one of the group consisting of a name of the first data attribute, a data type of the first data attribute, and a key attribute indicator of the first data attribute.

6. The system of claim 1, wherein the synthesizing engine establishes the first possible relationship using a data similarity advisor configured to generate a data similarity between values of the first data attribute and values of the second data attribute.

7. The system of claim 6, wherein the data consolidation engine generates a key transform that maps values of the first attribute to values of the second attribute.

8. The system of claim 1, wherein the synthesizing engine establishes the first possible relationship using an entity resolution advisor configured to determine whether at least one of the first data attribute and the second data attribute are entity IDs.

9. The system of claim 1, further comprising an analyzer that generates a frequency count as a function of a usage history containing historical requested datasets joined using previously defined relationships containing both the first attribute and the second attribute.

10. The system of claim 9, wherein the synthesizing engine is further configured to modify the first confidence metric as a function of the frequency count.

11. The system of claim 1, wherein the data consolidation engine is configured to synthesize the new dataset as a function of the first confidence metric when the first confidence metric is at least a defined threshold.

12. The system of claim 1, wherein the first data source comprises at least one of a relational database management system, a cloud service, and a poly-structured data.

13. The system of claim 1, wherein the synthesizing engine is configured to compare the similarity of a first name of the first data attribute and a second name of the second data attribute.

14. The system of claim 1, further comprising a interface module that presents the first confidence metric to a user interface.

15. The system of claim 14, wherein:
the synthesizing engine is further configured to establish a second possible relationship between a third data attribute of the first dataset and a fourth data attribute of the second dataset;
the synthesizing engine is further configured to generate a second confidence metric of less than 100% between the third data attribute and the fourth data attribute as a function of the second possible relationship; and
the interface module is further configured to present the second confidence metric to the user interface.

16. The system of claim 15, wherein the interface module is further configured to receive a selection of the first confidence metric from the user interface, and wherein the received selection triggers the data consolidation engine to synthesize the new dataset using the relationship associated with the selected confidence metric.

17. The system of claim 1, wherein:
the synthesizing engine is further configured to establish a second possible relationship between a third data attribute of the first dataset and a fourth data attribute of the second dataset;
the synthesizing engine is further configured to generate a second confidence metric of less than 100% between the third data attribute and the fourth data attribute as a function of the second possible relationship; and
the data consolidation engine is further configured to synthesize the new dataset using the relationship associated with the second confidence metric between the third data attribute and the fourth data attribute.

18. The system of claim 18, further comprising an API module that is configured to:
receive a selection of the first attribute and the second attribute from a calling computer system;
present the first confidence metric and the second confidence metric to the calling computer system; and
receive a selection of the first confidence metric from the calling computer system.
